(19) United States
(12) Patent Application Publication
(10) Pub. No.: US 2020/0394573 A1
(43) Pub. Date: Dec. 17, 2020

(54) Method for Obtaining Digital Key for Check-in a Room Reservation

(71) Applicant: Shih-Kang Chou, Taipei City (TW)

(72) Inventor: Shih-Kang Chou, Taipei City (TW)

(21) Appl. No.: 16/810,104

(22) Filed: Mar. 5, 2020

(30) Foreign Application Priority Data
Jun. 11, 2019 (TW) 108120063

(51) Int. Cl. G06Q 10/02; G06Q 10/10; G06Q 50/12; G07C 9/00; H04L 29/08

(52) U.S. Cl. CPC G06Q 10/02; G06Q 10/10; G06Q 50/12; G07C 9/00563; E05B 47/00; G07C 9/00904; H04L 67/141; G07C 2009/00833; G07C 9/00817

(57) ABSTRACT

Present invention provide a method for obtaining digital key for check-in the room reservation comprising steps as following. Firstly, a room reservation application is executed by a user for connecting to a room reservation website. The reservation website exchanges information with a hotel server of a hotel. When an order for reserving a room of the hotel is established on the room reservation website, the room reservation website or the hotel server transfers a reservation voucher for storing in the room reservation application. The user executes the room reservation application to connect with a wireless access point when arrives the hotel. Finally, the reservation voucher is then verified and a corresponded digital key for unlocking an electronic lock of the room is transmitted and stored in the room reservation application held by the user. The method provided by the present invention enables the user to access the wireless access point in the hotel upon arrival after the reservation voucher has been transmitted. The user could then use the reservation voucher to exchange for the digital key for unlocking the electronic lock of the hotel's room without waiting for check-in process at front desk of the hotel.

### FIELD OF INVENTION

Present invention relates to a technical field of room reservation, especially to a method for obtaining digital key for check-in the room reservation.

The present invention has been developed primarily to be obtaining a digital key for check-in the room reservation and will be described hereinafter with reference to this application. However, it will be appreciated that this invention is not limited to this particular field of use. Any reasonable alternation or substation shall not fail to fall within a protected scope of this invention.

### BACKGROUND OF THE INVENTION

It is more and more common for traveler makes a reservation online for their hotels. When the travelers arrive at hotel, they need to wait at front desk to settle all the check-in procedures for getting a key or an access card of the room.

It is very exhausting to the traveler for waiting the check-in procedure on the front desk after a long distance travel. If happens on tourist season, a crowd of tourists will wait in line before the front desk just to check-in and get their room key or access card. This normally will cause unpleasant travel experience to the traveler. Hence, it is eager to have a method for obtaining digital key for check-in the room reservation that will overcome or substantially ameliorate at least one or more of the deficiencies of a prior art, or to at least provide an alternative solution to the problems.

It is to be understood that, if any prior art information is referred to herein, such reference does not constitute an admission that the information forms part of the common general knowledge in the art.

### SUMMARY OF THE INVENTION

In order to solve the shortcomings of the conventional online hotel reservation still needs to go through all the complex and irritated check-in procedure, the present invention provide a more efficient and time saving method for obtaining digital key for check-in the room reservation.

The method comprises steps as following. A room reservation application is executed by a user for connecting to a room reservation website. The reservation website exchanges information with a hotel server of a hotel. When an order for reserving a room of the hotel is established on the room reservation website, the room reservation website or the hotel server transfers a reservation voucher for storing in the room reservation application. The user executes the room reservation application to connect with a wireless access point when arrives the hotel. The reservation voucher is then verified and a corresponded digital key for unlocking an electronic lock of the room is transmitted and stored in the room reservation application held by the user.

As describing above, the present invention has advantages as following.

The method provided by the present invention enables the user to access the wireless access point in the hotel upon arrival after the reservation voucher has been transmitted. The user could then use the reservation voucher to exchange for the digital key for unlocking the electronic lock of the hotel's room. The user hence is able to unlock the electronic lock of the hotel room by the digital key.

The reservation voucher of the present invention can be obtained via the wireless access point to exchange for the digital key for unlocking the reserved hotel room. When arriving the hotel, the user can quickly enter the reserved room without waiting for check-in process at front desk of the hotel.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a flow chart of a preferred embodiment in accordance to the present invention;

FIG. 2 is a perspective view of the preferred embodiment in accordance to the present invention; and

FIG. 3 is another perspective view of the preferred embodiment in accordance to the present invention.

### DETAILED DESCRIPTION OF THE PREFERRED EMBODIMENTS

In order to make purposes, technical solutions, and advantages of the present invention to be clearer, the following content provides some preferred embodiments in accordance to the present invention.

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean “including but not limited to”.

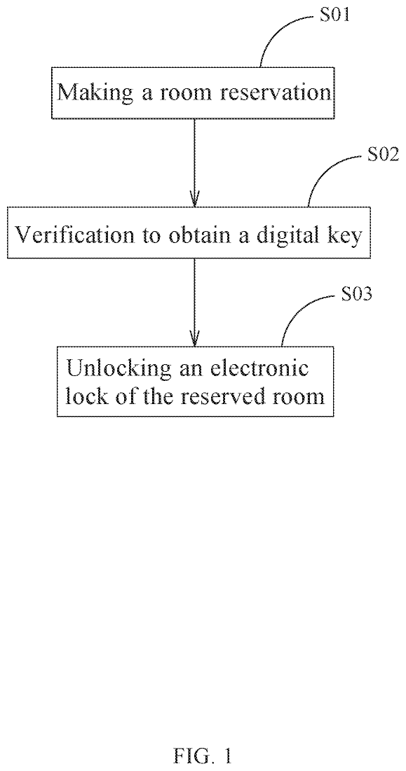

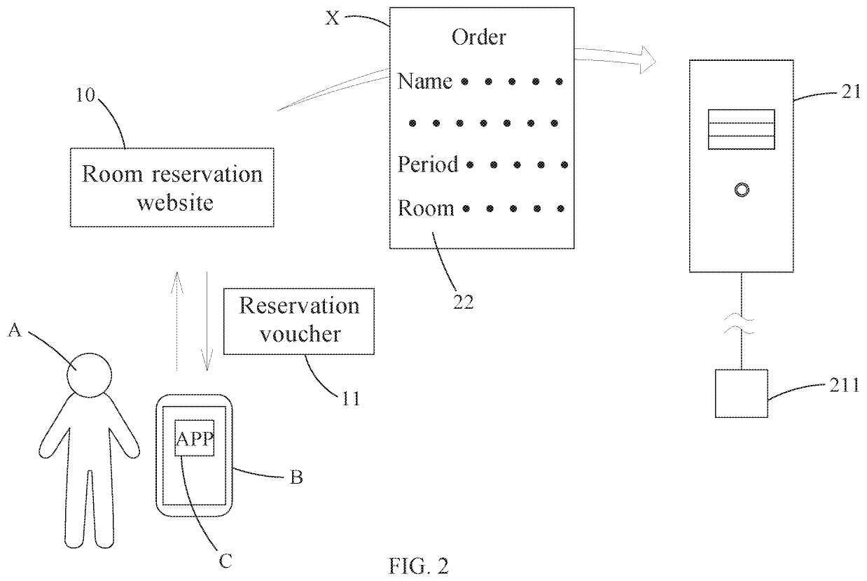

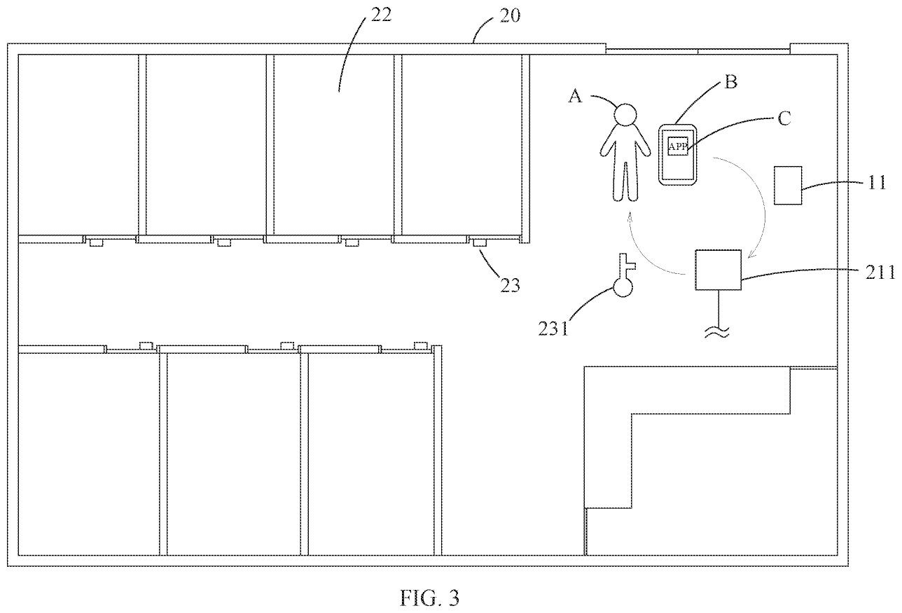

With reference to FIGS. 1 to 3, a preferred embodiment of a method for obtaining digital key for check-in the room reservation of the present invention is provided. The method for obtaining digital key for check-in the room reservation comprises a digital key delivering system. The digital key delivering system comprises a room reservation website 10. The room reservation website 10 comprises a server and a program code. The server is used to set up the room reservation website 10 and the program code is used to execute by the server. The room reservation website 10 exchanges information with a hotel server 21 of a hotel 20 via Internet. User(s) A or member(s) of the room reservation website 10 can install and execute a room reservation application C on their mobile device B, like mobile phone or tablet PC.

By executing the room reservation application C, user A is able to connect to the room reservation website 10 to make a reservation of a room 22 at the hotel 20. The room reservation website 10 will transmit a reservation order X to the hotel server 21 after the reservation is established. A wireless access point 211 is located in a lobby of the hotel 20 or other public space elsewhere to connect with the hotel server 21 by wired or wireless signals, like Bluetooth router. The reservation order X will be kept in valid for a period of time and the room 22 will be reserved by the hotel 20 for the reservation order X.

User A can access the hotel server 21 for authentication and obtaining a digital key by executing the room reservation application C and connecting to the wireless access point 211.

The method of the preset invention comprises steps as following.

S01—Making a room reservation: the user A executes the room reservation application C with the mobile device B and connects to the room reservation website 10 to make the room 22 reservation (order X). When the order X is established, the room reservation website 10 transfers the order X to the hotel server 21. As the hotel server 21 receives the order X from the user A by the room reservation website 10, the hotel 20 is able to confirm the reservation of the hotel room 22 by this order X. The order X records a passport number, gender, birth date, address and other detailed information of the user A as well as the check-in details, like reservation period and the room 22.

When the order X is cancelled by the user A, the room reservation website 10 will inform the hotel 20 that the order X has been cancelled and also invalid. If the order X is valid, the room reservation website 10 or the hotel server 21 will transmit a reservation voucher 11 to the user A by the Internet. The reservation voucher 11 will be stored in the room reservation application C. If the reservation voucher 11 is transmitted by the room reservation website 10 to the user A, the hotel server 21 will receive the reservation voucher 11 when the room reservation website 10 is connected with the hotel server 21.

S02—Verification to obtain a digital key: As the user A arrive the hotel 20 or other public space where has set up with the wireless access point 211, the user A could execute the room reservation application C to connect the wireless access point 211 with the hotel server 21. The hotel server 21 then will accept the access of the user A through the wireless access point 211. At this time, the hotel server 21 will firstly confirm if the order X is valid or was already cancelled by the user A. If the order X is still valid, the wireless access point 211 will verify the reservation voucher 11.

For the user A, this verification procedure is to verify the reservation voucher 11 and thereby exchange a digital key 231 corresponded to the reservation voucher 11 for storing or deposit in the room reservation application C of the user A. The digital key 231 can unlock an electronic lock 23 of the hotel room 22. As to the hotel server 21, the verification procedure is to verify the reservation voucher 11 of the user A and transmit the digital key 231 which can unlock the electronic lock 23 of the hotel room 22. Optionally, an electronic lock setting code will be transmitted along with the digital key 231 which the electronic lock setting code can be displayed on the room reservation application C and read by the user A.

S03—Unlocking the electronic lock of the reserved room (the room 22): When the user A arrives the hotel room 22, the user A connects the room reservation application C with the electronic lock 23 of the hotel room 22 and unlock the electronic lock 23 with the digital key 231. Optionally, the electronic lock 23 of the hotel room 22 can further comprises a keyboard for inputting electronic lock setting code, password or other unlocking means like fingerprint or face recognition. The electronic lock 23 accepts the user A to enter the electronic setting code via the keyboard and activates functions of the electronic lock 23 such as setting password, fingerprint or face appearance for unlocking.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method for obtaining digital key for check-in the room reservation comprising steps of:
a room reservation application is executed by a user for connecting to a room reservation website; the reservation website exchanges information with a hotel server of a hotel; when an order for reserving a room of the hotel is established on the room reservation website, the room reservation website or the hotel server transfers a reservation voucher for storing in the room reservation application; and
the user executes the room reservation application to connect with a wireless access point when arrives the hotel; the reservation voucher is then verified and a corresponded digital key for unlocking a electronic lock of the room is transmitted and stored in the room reservation application held by the user.

2. The method as claimed in claim 1, wherein: the user connects the room reservation application with the electronic lock of the room and unlocks the electronic lock by the digital key.

3. The method as claimed in claim 1, wherein: the wireless access point is a Bluetooth router; and the room reservation application is executed by a mobile device.

4. The method as claimed in claim 2, wherein: the wireless access point is a Bluetooth router; and the room reservation application is executed by a mobile device.

5. The method as claimed in claim 3, wherein: the room reservation website is connected to the hotel server via Internet; and the reservation voucher is transferred by the room reservation website or the hotel server and is stored by the room reservation application via Internet.

6. The method as claimed in claim 1, wherein: an electronic lock setting code is transmitted along with the digital key and is displayed on the room reservation application; the electronic lock of the hotel room comprises a keyboard for inputting the electronic lock setting code; and the electronic lock accepts the electronic setting code via the keyboard and activates functions of the electronic lock including setting password, fingerprint or face appearance for unlocking.

7. A method for obtaining digital key for check-in the room reservation comprising steps of:
a hotel server receives an order from a room reservation website and confirms a room for reservation; the room reservation website or the hotel server transmits a reservation voucher corresponded to the order to a user who made the reservation; and
the hotel server accepts a user to connect via a wireless access point at the hotel; and a digital key will be transmitted to the user after the hotel server verifies the reservation voucher.

8. The method as claimed in claim 7, wherein; a room reservation application is executed by a user's mobile device; the room reservation application is used to connect with the wireless access point for accepting and storing the reservation voucher and the digital key; and the user executes the room reservation application to connect with the electronic lock of the room for unlocking by the digital key.

9. The method as claimed in claim 7, wherein the wireless access point is a Bluetooth router; and the mobile device is a mobile phone.

10. The method as claimed in claim 8, wherein the wireless access point is a Bluetooth router; and the mobile device is a mobile phone.

11. The method as claimed in claim 9, wherein the hotel server accepts the order of the user form the room reservation website via Internet; and the reservation voucher is transmitted to the user by the room reservation website or the hotel server via Internet.

12. The method as claimed in claim 8, wherein an electronic lock setting code is transmitted to the user along with the digital key; the electronic lock setting code is displayed on the room reservation application on the user's mobile device; the electronic lock of the room comprises a keyboard for inputting the electronic lock setting code; and the electronic lock accepts the electronic setting code via the keyboard and activates functions of the electronic lock including setting password, fingerprint or face appearance for unlocking.
